(19) United States
(12) Patent Application Publication
(10) Pub. No.: US 2010/0192307 A1
(43) Pub. Date: Aug. 5, 2010

(54) METHOD FOR THE PRODUCTION OF AQUEOUS FORMULATIONS, AQUEOUS FORMULATIONS, AND THE USE THEREOF

(75) Inventors: Markus Brym, Mannheim (DE); Stephan Hüffer, Ludwigshafen (DE); Audrey Renoncourt, Ludwigshafen (DE); Ulrike Mahn, Mannheim (DE); Franz Glocknitzer, Edenkoben (DE)

Correspondence Address: CONNOLLY BOVE LODGE & HUTZ, LLP, P O BOX 2207, WILMINGTON, DE, 19899, US

(73) Assignee: BASF SE, Ludwigshfen (DE)

(21) Appl. No.: 12/676,263

(22) PCT Filed: Aug. 5, 2008
(86) PCT No.: PCT/EP2008/060255

§ 371 Date: Mar. 3, 2010

(30) Foreign Application Priority Data
Sep. 3, 2007 (EP) 07115514.7
Sep. 3, 2007 (EP) 07115518.8
Sep. 4, 2007 (EP) 07115644.2
Dec. 10, 2007 (EP) 07122718.5
Jan. 29, 2008 (EP) 08101061.3

(51) Int. Cl. D06M 13/184; C08F 222/38

(52) U.S. Cl. 8/94.33; 526/307.6

(57) ABSTRACT

Process for the preparation of aqueous formulations, aqueous formulations and their use

A process for the preparation of aqueous formulations, wherein
(A) at least one ethylenically unsaturated mono- or dicarboxylic acid or the anhydride thereof,
(B) at least one comonomer having at least one permanent cationic charge per molecule and
(C-P1) at least one ethylenically unsaturated carboxamide,
   are subjected to free radical copolymerization with one another in an aqueous medium.

Process for the preparation of aqueous formulations, aqueous formulations and their use

The present invention relates to a process for the preparation of aqueous formulations, wherein
(A) at least one ethylenically unsaturated mono- or dicarboxylic acid or the anhydride thereof,
(B) at least one comonomer having at least one permanent cationic charge per molecule and
(C) at least one ethylenically unsaturated carboxamide,
   are subjected to copolymerization with one another in an aqueous medium.

The present invention furthermore relates to aqueous formulations comprising at least one copolymer (D) obtainable by copolymerization of
(A) at least one ethylenically unsaturated mono- or dicarboxylic acid or the anhydride thereof,
(B) at least one comonomer having at least one permanent cationic charge per molecule and
(C) at least one ethylenically unsaturated carboxamide,
   and (E) if appropriate, at least one polymeric tanning or retanning agent.

The present invention furthermore relates to the use of aqueous formulations according to the invention for the production of leather, and leathers produced according to the invention which are suitable in particular for the production of upper leather, articles of apparel and pieces of furniture. The present invention furthermore relates to copolymers (D) and their mixture with at least one ethylenically unsaturated dicarboxylic acid or its anhydride.

In many applications, in particular for the production of upper leather, apparel and pieces of furniture, there is a need for soft leathers, i.e. leathers which have a soft and full sensation but nevertheless have sufficient strength. In order to produce sufficiently soft leathers, not only can the finish be appropriately chosen but also the softness can be influenced during the tanning or in particular the retanning itself by the choice of a suitable tanning or retanning agent.

It is known that aqueous formulations of (co)polymers of ethylenically unsaturated carboxylic acids can be used as tanning or retanning agents. However, some (co)polymers of ethylenically unsaturated carboxylic acids do not give sufficiently soft leathers.

It was therefore the object to provide a process by means of which aqueous formulations which are suitable for the production of particularly soft and full leathers which have good strength and can be readily dyed can be produced.

It was furthermore the object to provide aqueous formulations which are suitable for the production of particularly soft and full leathers which have good strength and can be readily dyed. In addition, it was the object to provide particularly soft and full leathers which have good strength and can be readily dyed, and potential uses.

Accordingly, the process defined at the outset was found, also referred to below as preparation process according to the invention.

For carrying out the preparation process according to the invention, the following are subjected to free radical copolymerization with one another in preferably aqueous medium:
(A) at least one ethylenically unsaturated mono- or dicarboxylic acid or the anhydride thereof, preferably at least one ethylenically unsaturated C₃-C₁₀-carboxylic acid, for example (E)- or (Z)-crotonic acid or in particular methacrylic acid or acrylic acid, or at least one ethylenically unsaturated C₄-C₁₀-dicarboxylic acid or its anhydride, for example maleic acid, maleic anhydride, fumaric acid, itaconic acid, itaconic anhydride, metaconic acid, metaconic anhydride and citraconic acid, itaconic anhydride and in particular maleic anhydride being preferred,
(B) at least one comonomer having at least one permanent cationic charge per molecule, preferably exactly one permanent cationic charge per molecule, and
(C) at least one ethylenically unsaturated carboxamide.

Comonomers having at least one permanent cationic charge per molecule (B), also referred to for short as comonomer (B) in the context of the present invention, are to be understood as meaning ethylenically unsaturated compounds which, independently of the pH, have at least one cationic charge per molecule. Accordingly, comonomers having exactly one permanent cationic charge per molecule are to be understood as meaning those ethylenically unsaturated compounds which, independently of the pH, have exactly one cationic charge per molecule.

Comonomer (B) can be selected from heterocyclic comonomers having at least one permanent cationic charge per molecule, also referred to below as heterocyclic comonomers (B) for short, or from acyclic comonomers having at least one permanent cationic charge per molecule, also referred to below as acyclic comonomers (B) for short. Heterocyclic comonomer (B) or acyclic comonomer (B) preferably has exactly one permanent cationic charge per molecule.

Examples of heterocyclic comonomers (B) are olefins quaternized with C₁-C₄-alkyl, preferably with primary or secondary C₁-C₄-alkyl, such as methyl, ethyl, n-propyl, isopropyl, n-butyl, isobutyl or sec-butyl, and having a nitrogen-containing heterocyclic structure.

In general, anions which are inert to free radical reactions, for example carboxylates without ethylenic double bonds, can serve as a counterion for neutralizing the positive charge. Acetates, benzoates and propionates may be mentioned by way of example. Furthermore, halide ions, for example bromide and in particular chloride, and in addition tetrafluoroborate, hydrogen sulfate, C₁-C₄-alkylsulfate, such as, in particular, ethyl sulfate and methyl sulfate, and also sulfate, may be mentioned as a counterion.

Examples of heterocyclic comonomers (B) are comonomers of the general formulae I a to I c

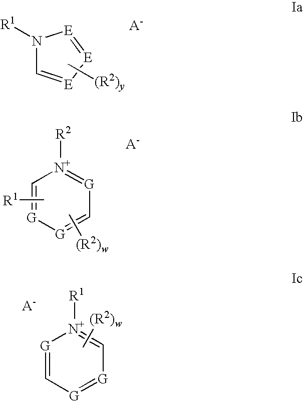

where the variables are selected as follows:

R¹ is selected from C₂-ω-C₁₀-alkenyl, for example vinyl, w-allyl (CH₂═CH—CH₂—), referred to as allyl for short in the context of the present invention unless expressly stated otherwise, ω-homoallyl (CH₂═CH—CH₂—CH₂—), ₚreferably allyl and particularly preferably vinyl.

R² is, if possible, different or preferably identical and is selected from preferably primary C₁-C₁₀-alkyl, for example methyl, ethyl, n-propyl, n-butyl, n-pentyl, n-hexyl, n-heptyl, n-octyl, n-nonyl, n-decyl, preferably from primary C₁-C₄-alkyl, such as methyl, ethyl, n-propyl, n-butyl and in particular methyl,

y is an integer and is selected from 1, 2 or 3. y is preferably 1,

w is an integer and is selected from zero, 1, 2 or 3, w is preferably 1 and w is particularly preferably zero.

E is selected from nitrogen and C—H, at least one E being nitrogen and it being preferable if, in formula I a, not more than two neighboring positions in the ring are nitrogen. Thus, the olefins of the general formula I a may preferably be:

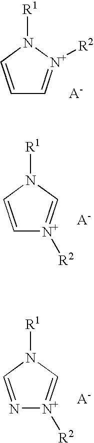

G is selected from N and C—H, with the proviso that, where G is N, the relevant G is not substituted by R².

A⁻ is an anion which is inert to free radical reactions, for example carboxylates without ethylenic double bonds. Acetates, benzoates and propionates may be mentioned by way of example. Halide ions, for example bromide and in particular chloride, and in addition tetrafluoroborate, hydrogen sulfate and sulfate, may furthermore be mentioned as an anion. A⁻ is very particularly preferably selected from C₁-C₄-alkylsulfate, for example methylsulfate or ethylsulfate.

Particularly preferred heterocyclic comonomers (B) are ortho-, meta- or para-vinyl-n-C₁-C₄-alkylpyridinium or N-vinyl-3-C₁-C₄-alkylimidazolium quaternized with C₁-C₄-alkyl, preferably with primary or secondary C₁-C₄-alkyl. 3-Methyl-N-vinylimidazolium is very particularly preferred.

Examples of preferred acyclic comonomers (B) are olefins of the general formula [(R³)ₓN(R⁴)₄₋ₓ]⁺k where the variables are selected as follows:

R³ is, if possible, different or preferably identical and is selected from C₂-ω-C₁₀-alkenyl, for example vinyl, ω-allyl (CH₂═CH—CH₂—), referred to as allyl for short in the context of the present invention unless expressly stated otherwise, w-homoallyl (CH₂═CH—CH₂—CH₂—), preferably vinyl and particularly preferably allyl.

R⁴ is, if possible, different or preferably identical and is selected from preferably primary C₁-C₁₀-alkyl, for example methyl, ethyl, n-propyl, n-butyl, n-pentyl, n-hexyl, n-heptyl, n-octyl, n-nonyl, n-decyl, preferably from primary C₁-C₄-alkyl, such as methyl, ethyl, n-propyl, n-butyl and in particular methyl,

x is an integer and is selected from 1, 3 and preferably 2.

In an embodiment of the present invention, diallyldi(C₁-C₄-alkyl)ammonium halides, in particular the chlorides, are selected as acyclic comonomer (B). Diallyldimethylammonium chloride (DADMAC) is very particularly preferred.

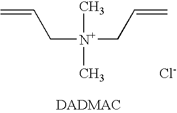

A further comonomer is at least one ethylenically unsaturated carboxamide (C), Ethylenically unsaturated carboxamide (C) is a compound which carries no permanent cationic charge. Methacrylamide and in particular acrylamide are preferred.

For carrying out the preparation process according to the invention, copolymerization is effected in an aqueous medium, preferably in aqueous solution.

For carrying out the preparation process according to the invention, free radical copolymerization is effected, i.e. with the use of at least one inorganic or organic free radical initiator, such as, for example, a peroxide or hydroperoxide. Di-tert-butyl peroxide, tert-butyl peroctanoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide and dicyclohexyl peroxodicarbonate may be mentioned by way of example as peroxides or hydroperoxides.

Examples of inorganic free radical initiators are alkali metal peroxodisulfates, in particular sodium peroxodisulfate and potassium peroxodisulfate. The use of redox initiators is also suitable, for example combinations of hydrogen peroxide or sodium peroxodisulfate or one of the abovementioned peroxides with at least one reducing agent. For example, the following are suitable reducing agents: ascorbic acid, tartaric acid, Fe(II) salts, such as, for example, FeSO₄, sodium bisulfite, and potassium bisulfite. Furthermore, combinations of at least one peroxide, in particular hydrogen peroxide, with copper(II) salts, such as, for example, copper sulfate, are suitable.

Other suitable free radical initiators are azo compounds, such as 2,2′-azobis(isobutyronitrile), 2,2′-azobis(2-amidinopropane) dihydrochloride (2,2′-azobis(2-methylpropionamidine)dihydrochloride) and 2,2′-azobis(4-methoxy-2,4-dimethylvaleronitrile).

In an embodiment of the present invention, the copolymerization can be carried out at pressures in the range from 1.1 to 10 bar. However it is preferable to carry out the copolymerization at atmospheric pressure.

In an embodiment of the present invention, the copolymerization is carried out at temperatures in the range from 65 to 120° C., preferably from 80 to 115° C.

In an embodiment of the present invention, the copolymerization is carried out over a period in the range from 30 minutes to 10 hours.

In an embodiment of the present invention, the copolymerization is carried out at a pH in the range from 1 to 10, preferably from 1 to 7.

Some of the comonomers may be strongly acidic; in this case, the pH can be adjusted with the aid of a base or partial or complete neutralization can be effected. In another embodiment of the present invention, the neutralization before or during the copolymerization is omitted and copolymerization is effected at strongly acidic pH.

Before, during or after the copolymerization, partial or complete neutralization can be effected, preferably with one or more basic alkali metal salts, with ammonia or with basic amine. Examples of basic amines are ethylamine, diethylamine, triethylamine, n-propylamine, di-n-propylamine, N,N-diethanolamine, ethanolamine, N-methylethanolamine, N,N-dimethylethanolamine, N-methyl-N,N-diethanolamine, N-(n-propyl)ethanolamine, N-(n-butyl)ethanolamine and N-(n-butyl)-N,N-diethanolamine. Examples of basic alkali metal compounds are carbonates, bicarbonates and in particular hydroxides of alkali metals, in particular of potassium or sodium. Potassium hydroxide and sodium hydroxide are particularly preferred.

In an embodiment of the present invention, the comonomers are used in the following weight ratios:

in the range of from 1 to 30% by weight, preferably from 5 to 20% by weight, of ethylenically unsaturated mono- or dicarboxylic acid or the anhydride thereof (A), in the range of from 5 to 60% by weight, preferably from 10 to 45% by weight, of comonomer (B),

in the range of from 30 to 80% by weight, preferably from 40 to 60% by weight, of ethylenically unsaturated carboxamide (C).

Data in % by weight are based on total copolymer according to the invention.

In an embodiment of the present invention, one or more further comonomers can be incorporated in the form of polymerized units, for example one or more C₁-C₂-alkyl esters or ω-hydroxy-C₁-C₃-alkyl esters of (meth)acrylic acid. Further suitable comonomers are acrylonitrile and vinyl aromatics, such as, for example, styrene. It is preferable if the proportion of further comonomers does not exceed 50 parts by weight, based on the sum of ethylenically unsaturated mono- or dicarboxylic acid or the anhydride thereof (A), comonomer (B) and ethylenically unsaturated carboxamide (C). In the case of vinyl aromatics, the proportion of further comonomers should not exceed 5 parts by weight, based on the sum of ethylenically unsaturated mono- or dicarboxylic acid or the anhydride thereof (A), comonomer (B) and ethylenically unsaturated carboxamide (C).

In a preferred embodiment of the present invention, no further comonomers are incorporated in the form of polymerized units, in particular none of the comonomers mentioned in the above paragraph.

By carrying out the preparation process according to the invention, an aqueous formulation comprising copolymer (D) and, if appropriate, certain proportions of residual monomers is obtained.

Aqueous formulations prepared by the preparation process according to the invention may have a solids content in the range from 1 to 80%, preferably from 10 to 50%.

In an embodiment of the present invention, copolymer (D) prepared by the preparation process according to the invention has a K value in the range of from 10 to 80, preferably from 20 to 60, determined according to Fikentscher on a 1% by weight aqueous solution at room temperature.

Aqueous formulations prepared by the preparation process according to the invention can be used for the production of leather, preferably for tanning and in particular for retanning.

In an embodiment of the present invention, aqueous formulation prepared by the preparation process according to the invention is mixed with at least one polymeric tanning or retanning agent (E).

Polymeric tanning and retanning agents (E) are known as such. Examples are the homo- and copolymers mentioned in EP 1 335 029 A1 as tanning agents A) to L) and the copolymers mentioned in WO 2004/070063, and in WO 2005/019480 and those mentioned in WO 2006/015745, terpolymers being included.

In an embodiment, polymeric tanning or retanning agent (E) is selected from homo- and copolymers of ethylenically unsaturated carboxylic acids (A), in particular from (meth)acrylic acid. In particular, the homo- and copolymers mentioned in EP 1 335 029 A1 as tanning agents A) to D) and the copolymers mentioned in WO 2005/019480 and those mentioned in WO 2006/015745 are preferred, terpolymers being included.

Very particularly preferred polymeric tanning and retanning agents (E) are homopolymers of (meth)acrylic acid, in particular having a molecular weight M_{w} in the range from 1000 to 200 000 g/mol.

Very particularly preferred polymeric tanning and retanning agents (E) are homopolymers of (meth)acrylic acid having a K value according to Fikentscher in the range from 10 to 120, preferably from 60 to 100, determined on the 1% by weight aqueous solution neutralized with NaOH (pH 7) at 23° C.

In an embodiment of the present invention, copolymer (D) according to the invention is mixed, for example in aqueous formulation, with an amount of polymeric tanning or retanning agent (E) such that an aqueous formulation is obtained which comprises, based on its total amount, from 5 to 50% by weight, preferably from 15 to 30% by weight, of copolymer (D), a corresponding amount of ethylenically unsaturated dicarboxylic acid (C-P2) or its anhydride and from 1 to 30% by weight, preferably from 5 to 15% by weight, of polymeric tanning or retanning agent (E).

The sequence of addition of aqueous formulation prepared by the preparation process according to the invention and polymeric tanning or retanning agent (E) is arbitrary.

Polymeric tanning or retanning agent (E) can be used as a solid or preferably as an aqueous solution or dispersion.

The present invention furthermore relates to aqueous formulations obtainable by mixing aqueous formulations obtainable by the preparation process according to the invention with at least one tanning or retanning agent (E).

The present invention furthermore relates to aqueous formulations comprising (D) at least one copolymer obtainable by copolymerization of
(A) at least one ethylenically unsaturated mono- or dicarboxylic acid or the anhydride thereof,
(B) at least one comonomer having at least one permanent cationic charge per molecule and
(C) at least one ethylenically unsaturated carboxamide,
   if appropriate (E) at least one polymeric tanning or retanning agent.

The aqueous formulations defined above are also referred to as aqueous formulations according to the invention.

Polymeric tanning and retanning agents (E) are known as such. Examples are the homo- and copolymers mentioned in EP 1 335 029 A1 as tanning agents A) to L) and N) and the copolymers mentioned in WO 2004/070063, and in WO 2005/019480 and those mentioned in WO 2006/015745, terpolymers being included.

In an embodiment, polymeric tanning or retanning agent (E) is selected from homo- and copolymers of ethylenically unsaturated carboxylic acids (A), in particular of (meth)acrylic acid, In particular, the homo- and copolymers mentioned in EP 1 335 029 A1 as tanning agents A) to D) and the copolymers mentioned in WO 2005/019480 and those mentioned in WO 2006/015745 are preferred, terpolymers being included.

Very particularly preferred polymeric tanning and retanning agents (E) are homopolymers of (meth)acrylic acid, in particular having a molecular weight M_{w} in the range from 1000 to 200 000 g/mol.

Very particularly preferred polymeric tanning and retanning agents (E) are homopolymers of (meth)acrylic acid having a K value according to Fikentscher in the range from 10 to 120, preferably from 60 to 100, determined on the 1% by weight aqueous solution neutralized with NaOH (pH 7) at 23° C.

Ethylenically unsaturated mono- or dicarboxylic acid or the anhydride thereof (A), comonomer (B), ethylenically unsaturated dicarboxylic acid (C-P1) or its anhydride and ethylenically unsaturated dicarboxylic acid (C-P2) or its anhydride are described above.

Aqueous formulations according to the invention may have a solids content in the range from 1 to 80%, preferably from 10 to 50%.

Aqueous formulations according to the invention may have a pH in the range from 5.5 to 11, preferably from 7 to 9.

The present invention furthermore relates to the use of aqueous formulations according to the invention for the production of leather. The present invention furthermore relates to a process for the production of leather using aqueous formulations according to the invention. The present invention furthermore relates to leather produced using at least one aqueous formulation according to the invention.

In an embodiment of the present invention, the process according to the invention for the production of leather is carried out as a tanning process, also referred to below as tanning process according to the invention, preferably as a retanning process, also referred to below as retanning process according to the invention.

The tanning process according to the invention is carried out in general in a manner such that at least one aqueous formulation according to the invention is added in one portion or in a plurality of portions immediately before or during the tanning step. The tanning process according to the invention is preferably carried out at a pH of from 2.5 to 11, preferably up to 4, it frequently being observed that the pH increases by about 0.3 to three units while the tanning process according to the invention is being carried out.

The tanning process according to the invention is carried out in general at temperatures of from 10 to 45° C., preferably at from 20 to 30° C. A duration of from 10 minutes to 12 hours has proven useful, and from one to three hours are preferred. The tanning process according to the invention can be carried out in any desired vessels customary in tanning, for example by drumming in barrels or in rotated drums.

In an embodiment of the present invention, altogether from 0.01 to 10% by weight of aqueous formulation according to the invention is used, based on the solids content of aqueous formulation according to the invention on the one hand and on the shaved weight on the other hand; from 0.5 to 5% by weight are preferred.

In a variant of the tanning process according to the invention, aqueous formulation according to the invention is used together with one or more conventional tanning agents, for example with chrome tanning agents, mineral tanning agents, syntans, polymer tanning agents or vegetable tanning agents, as described, for example, in Ullmann's Encyclopedia of Industrial Chemistry, Volume A15, pages 259 to 282 and in particular page 268 et seq., 5^{th} edition, (1990), Verlag Chemie Weinheim. The weight ratio of aqueous formulation according to the invention: conventional tanning agent or sum of the conventional tanning agents is expediently from 0.01:1 to 100:1 (based in each case on the solids contents). In an advantageous variant of the tanning process according to the invention only a few ppm of conventional tanning agent are added to aqueous formulation according to the invention.

In a variant of the tanning process according to the invention, aqueous formulation according to the invention is used together with one or more fat liquoring agents or oleophilic components.

In a variant of the tanning process according to the invention, aqueous formulation according to the invention is added in one portion or in a plurality of portions before or during the pretanning. An addition in the pickle is also conceivable.

The retanning process according to the invention is carried out starting from conventionally tanned semi-finished products, i.e. for example semi-finished products tanned with chrome tanning agents, mineral tanning agents, polymer tanning agents, aldehydes, syntans or resin tanning agents, or semi-finished products produced according to the invention as described above. For carrying out the retanning process according to the invention, at least one aqueous formulation according to the invention is allowed to act on semi-finished products, i.e. treatment with at least one aqueous formulation according to the invention is effected.

The retanning process according to the invention can be carried out under otherwise customary conditions. Expediently, one or more, i.e. from 2 to 6, treatment steps are chosen and washing with water may be effected between the treatment steps. The temperature during the individual treatment steps is in each case from 5 to 60° C., preferably from 20 to 45° C. Expediently, one or more further compositions usually used during the retanning are employed, for example fat liquors, polymer tanning agents and acrylate- and/or methacrylate-based fat liquoring agents, retanning agents based on vegetable tanning agents, fillers, leather dyes or emulsifiers.

A duration of from 10 minutes to 12 hours has proven useful for the retanning process according to the invention, and from one to three hours are preferred. The retanning process according to the invention can be carried out in any desired vessels customary in tanning, for example by drumming in barrels or in rotated drums.

In an embodiment of the retanning process according to the invention altogether from 0.01 to 10% by weight of aqueous formulation according to the invention are used, based on the solids content of aqueous formulation according to the invention on the one hand and on the shaved weight on the other hand; from 0.5 to 5% by weight are preferred.

The present invention furthermore relates to leather produced by the process according to the invention. Leather according to the invention is distinguished by good fullness, softness and intensity and wash resistance of the dyeing and further good performance characteristics. Leather according to the invention is suitable, for example, for the production of upper leather, articles of apparel, such as, for example, jackets, coats or pants, and furthermore of pieces of furniture.

The present invention furthermore relates to copolymers, also referred to as copolymers (D) in the context of the present invention. Copolymers (D) according to the invention comprise incorporated in the form of polymerized units:
(A) at least one ethylenically unsaturated mono- or dicarboxylic acid or the anhydride thereof,
(B) at least one comonomer having at least one permanent cationic charge per molecule and
(C) at least one ethylenically unsaturated carboxamide.

Ethylenically unsaturated mono- or dicarboxylic acid or the anhydrides thereof (A), comonomers (B) and ethylenically unsaturated carboxamides (C) are described above. Processes for the preparation of copolymers (D) according to the invention are likewise described above.

Copolymers (D) according to the invention may be partly or completely neutralized with ammonia, basic amine or basic alkali metal compound, in particular with potassium hydroxide or sodium hydroxide.

In an embodiment of the present invention, copolymers (D) according to the invention comprise incorporated in the form of polymerized units:

in the range from 1 to 30% by weight, preferably from 5 to 20% by weight, of ethylenically unsaturated mono- or dicarboxylic acid or the anhydride thereof (A), in the range from 5 to 60% by weight, preferably from 10 to 45% by weight, of comonomer (B),

in the range from 30 to 80% by weight, preferably from 40 to 60% by weight, of ethylenically unsaturated carboxamide (C).

In an embodiment of the present invention, copolymer (D) according to the invention has a K value in the range from 10 to 80, preferably from 20 to 60, determined according to Fikentscher on a 1% by weight aqueous solution at room temperature.

In an embodiment of the present invention, copolymers (D) according to the invention have an average molecular weight M_{w} in the range from 2000 to 100 000 g/mol, preferably in the range from 9000 to 15 000 g/mol. In another embodiment of the present invention, copolymers (D) according to the invention have an average molecular weight M_{w} in the range from above 100 000 g/mol to 500 000 g/mol, measured in each case by gel permeation chromatography (GPC).

The present invention furthermore relates to mixtures of copolymer (D) according to the invention with at least one polymeric tanning or retanning agent (E). Polymeric tanning and retanning agents (E) are described above.

If it is desired to prepare mixtures according to the invention or copolymer (D) according to the invention in anhydrous form, it is possible, for example, to adopt a procedure in which first, as described above, an aqueous formulation of copolymer (D) according to the invention is prepared and, if appropriate, ethylenically unsaturated dicarboxylic acid (CP-2) or its anhydride or, if appropriate, polymeric tanning or retanning agent (D) is added and the water is then removed by methods known per se. It is preferable to remove the water by evaporation, in particular by spray drying.

In an embodiment of the present invention, the weight ratio of copolymer (D) according to the invention to polymeric tanning or retanning agent (E) in mixtures according to the invention is in the range from 50:1 to 1:6, preferably from 3:1 to 1:3.

The present invention furthermore relates to aqueous formulations comprising at least one copolymer (D) according to the invention. The present invention furthermore relates to aqueous formulations comprising at least one of the mixtures described above.

Abovementioned aqueous formulations according to the invention may have a solids content in the range from 1 to 80%, preferably from 10 to 50%.

Copolymers according to the invention and mixtures according to the invention, particularly in the form of aqueous formulations, are very suitable for the production of leather.

The invention is explained by working examples.

I. Preparation according to the, invention of copolymers (D)

I.1 Preparation of copolymer (D.1) according to the invention

The following solutions were prepared:

Solution I.1.1: 2.5 g of a 50% by weight aqueous solution of H₂O₂

Solution I.1.2: The following were mixed while cooling with ice:

1.7 g of hydroxylammmonium sulfate [(NH₃OH)₂ SO₄]

45 g of acrylic acid (A.1)

300 g of 3-methyl-N-vinylimidazolium methylsulfate (QVI sulfate) (B.1)

45 g of 25% by weight aqueous sodium hydroxide solution and 276.5 g of distilled water, the sodium hydroxide solution being added last,

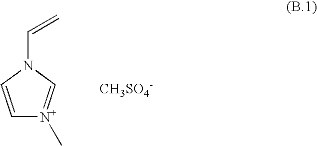

Thereafter,

360 g of acrylamide (C.1)

and 30 g of 25% by weight aqueous sodium hydroxide solution were added. The pH was 5. 0.03 g of CuSO₄.5 H₂O was then added,

Solution I.1.3: 24.5 g of a 50% by weight aqueous solution of H₂O₂ were diluted with 220 g of distilled water.

48 ml of distilled water and 132 g of the solution I.1.2 were initially taken in a 2 liter stirred vessel having a plurality of feeds and a reflux condenser and a gas inlet tube, Nitrogen was then allowed to bubble through the initially taken mixture (15 minutes) and heating to 95° C. was effected with stirring and solution I.1.1 was rapidly added.

Thereafter, the additions of the remaining proportion of solution I.1.2 and of solution I.1.3 were begun simultaneously. The remaining proportion of solution I.1.2 was added in the course of 4 hours and solution I.1.3 in the course of 5 hours, stirring being continued. Stirring was effected for a further 3 hours at 95° C. and the mixture was then allowed to cool to 60° C. 13.5 g of 50% by weight aqueous sodium hydroxide solution were then added in the course of 30 minutes. Cooling to 50° C. was then effected and 1.3 g of 70% by weight aqueous tert-butyl hydroperoxide solution were added. Thereafter, cooling to room temperature was effected and 7.9 g of a 10% by weight aqueous solution of disodium 2-hydroxysulfinatoacetate, Na₂C₂H₄O₅S, were added. Thereafter, a biocide was also added, in particular 2.16 g of a 20% by weight solution of 1,2-benzisothiazolin-3-one (“BIT”) in propylene glycol.

Aqueous formulation WF.1 according to the invention which had a pH of 7 and a solids content of 28.3% and comprised the copolymer (D.1) according to the invention was obtained. The K value (according to Fikentscher), measured at room temperature on an aqueous formulation WF.1 diluted to a solids content of 1% by weight, was 22.7. The average molecular weight M_{w} was 11 700 g/mol, determined by gel permeation chromatography.

I.2 Preparation of Copolymer (D.2) According to the Invention

The following solutions were prepared:

Solution I.2.1: 17.7 g of a 7% by weight aqueous solution of Na₂S₂O₈.

Solution I.2.2: The following were mixed while cooling with ice:

1.7 g of hydroxylammmonium sulfate [(NH₃OH)₂ SO₄]

88.6 g of acrylic acid (A.1)

88.6 g of 3-methyl-N-vinylimidazolium methylsulfate (QVI sulfate) (B.1)

88.6 g of 25% by weight aqueous sodium hydroxide solution

and 380.5 g of distilled water, the sodium hydroxide solution being added last.

Thereafter,

354.4 g of acrylamide (C.1) as a 50% by weight aqueous solution

and 54,5 g of 25% by weight aqueous sodium hydroxide solution were added. The pH was 5,

Solution I.2.3: 172.1 g of a 7% by weight aqueous solution of Na₂S₂O₈.

47.4 ml of distilled water and 132.1 g of the solution I.2,2 were initially taken in a 2 liter stirred vessel having a plurality of feeds and a reflux condenser and gas inlet tube. Nitrogen was then allowed to bubble through the initially taken mixture (15 minutes) and heating to 95° C. was effected with stirring and solution I.2.1 was rapidly added.

Thereafter, the additions of the remaining proportion of solution I.2.2 and of solution I.2.3 were simultaneously begun. The remaining proportion of solution I.2.2 was added in the course of 4 hours and solution I.2,3 in the course of 5 hours, stirring being continued. Stirring was effected for a further 3 hours at 95° C. and the mixture was then allowed to cool to 60° C. Thereafter, 28.1 g of 50% by weight aqueous sodium hydroxide solution were added in the course of 30 minutes, Thereafter, cooling to 50° C. was effected and 1.3 g of 70% by weight aqueous tert-butyl hydroperoxide solution were added. Thereafter, cooling to room temperature was effected and 7.8 g of a 10% by weight aqueous solution of disodium 2-hydroxysulfinatoacetate (Na₂C₂H₄O₅S) were added. A biocide was then also added, in particular 2.13 g of a 10% by weight solution of 1,2-benzisothiazolin-3-one (“BIT”) in propylene glycol.

Aqueous formulation WF.2 according to the invention which had a pH of 7.5 and a solids content of 31.5% and comprised copolymer (D.2) according to the invention was obtained, The K value (according to Fikentscher), measured at room temperature on an aqueous formulation WF.2 diluted to a solids content of 1% by weight, was 52.5.

I.3 Preparation of Copolymer (D.3) According to the Invention

The following solutions were prepared:

Solution I.3.1: 2.4 g of a 50% by weight aqueous solution of H₂O₂.

Solution I.3.2: The following were mixed while cooling with ice:

1.6 g of hydroxylammmonium sulfate [(NH₃OH)₂ SO₄]

98.0 g of acrylic acid (A.1)

47.7 g of 3-methyl-N-vinylimidazolium methylsulfate (QVI sulfate) (B.1)

98.0 g of 25% by weight aqueous sodium hydroxide solution

and 505.4 g of distilled water, the sodium hydroxide solution being added last.

Thereafter,

391.5 g of acrylamide (C.1) as 50% by weight aqueous solution, 0.02 g of copper(II) sulfate

and 69.0 g of 25% by weight sodium hydroxide solution were added. The pH was 4.5.

Solution I.3.3: 23.2 g of a 50% by weight aqueous solution of H₂O₂.

45.7 ml of distilled water and 151.4 g of the solution I.3.2 were initially taken in a 2 liter stirred vessel having a plurality of feeds and a reflux condenser and gas inlet tube. Nitrogen was then allowed to bubble through the initially taken mixture (15 minutes) and heating to 95° C. was effected with stirring and solution I.3.1 was rapidly added.

Thereafter, the additions of the remaining proportion of solution I.3.2 and of solution I.3.3 were simultaneously begun. The remaining proportion of solution I.3.2 was added in the course of 4 hours and solution I.2.3 in the course of 5 hours, stirring being continued. Stirring was effected for a further 3 hours at 95° C. and the mixture was then allowed to cool to 60° C. Thereafter, 27.5 g of 25% by weight aqueous sodium hydroxide solution were added in the course of 30 minutes. Cooling to 50° C. was then effected and 1.2 g of 70% by weight aqueous tert-butyl hydroperoxide solution were added. Thereafter, cooling to room temperature was effected and 1.8 g of a 10% by weight aqueous solution of disodium 2-hydroxysulfinatoacetate (Na₂C₂H₄O₅S) were added. A biocide was then also added, in particular 2.1 g of a 10% by weight solution of 1,2-benzisothiazolin-3-one (“BIT”) in propylene glycol.

Aqueous formulation WF.3 according to the invention, which had a pH of 7.2 and a solids content of 29.3% and comprised the copolymer (D.3) according to the invention was obtained. The K value (according to Fikentscher), measured at room temperature on an aqueous formulation WF.3 diluted to a solids content of 1% by weight, was 47.6.

I.6 Preparation of Copolymer (D.6) According to the Invention:

The following solutions were prepared:

Solution I.6.1: 19.4 g of a 7% by weight aqueous solution of Na₂S₂O₈.

Solution I.6.2: The following were mixed while cooling with ice:

48.5 g of acrylic acid (A.1)

296.5 g of a 49% by weight aqueous solution of 3-methyl-N-vinylimidazolium methyl sulfate (QVI sulfate) (B.1)

and 297.5 g of distilled water.

Thereafter,

387.0 g of a 50% by weight aqueous solution of acrylamide (C.1) were added.

Solution I.6.3: 188 g of a 7% by weight aqueous solution of Na₂S₂O₈.

51.7 ml of distilled water and 128.6 g of solution I.6.2 were initially taken in a 2 liter stirred vessel having a plurality of feeds, a reflux condenser and a gas inlet tube.

Thereafter, nitrogen was allowed to bubble through the initially taken mixture (15 minutes) and heating to 85° C. was effected with stirring. As soon as the internal temperature had reached 70° C., i.e. during the heating-up, solution I.6.1 was rapidly added.

At an internal temperature of 85° C., the addition of the remaining proportion of solution I.6.2 and of solution I.6.3 was begun simultaneously. The remaining proportion of solution I.6.2 was added in the course of 4 hours and solution I.6.3 in the course of 5 hours, stirring being continued. Stirring was effected for about 3 hours at 85° C. and the mixture was then allowed to cool to 60° C. Thereafter, 119.5 g of 25% by weight aqueous sodium hydroxide solution were added in the course of 30 minutes. Thereafter, cooling to room temperature was effected and a biocide was added, in particular 2.3 g of a 10% by weight solution of 1,2-benzoisothiazolin-3-one (“BIT”) in propylene glycol.

Aqueous formulation WF.6 according to the invention, having a pH of 8.2 and a solids content of 31.1% and comprising copolymer (D.6) according to the invention, was obtained. The K value (according to Fikentscher), measured at room temperature on an aqueous formulation WF.6, diluted to a solids content of 1% by weight, was 38.4. The molecular weight M_{w} of copolymer (D.6) according to the invention was 102 000 g/mol, determined by GPC.

II. Retanning Experiments with Copolymers According to the Invention and Comparative Copolymers V-CP.4 and V-CP.5

Production of Upper Leather (General Method)

Data in % are always % by weight and relate to the shaved weight. In the case of aqueous formulations, the data in % always relate to the proportion of solid or of active substance, unless expressly stated otherwise.

Four commercial cattle wetblue (from Packer, USA) were shaved to a thickness of from 1.5 to 1.8 mm. The core region was cut in each case into three strips of about 1700 g each. Thereafter, 1.5% by weight of sodium formate and 0.5% of sodium bicarbonate and 1% of a naphthalenesulfonic acid/formaldehyde condensate, prepared according to U.S. Pat. No. 5,186,846, example “Dispersant 1”, were added to the strips in a drum (50 l) and with a liquor length of 200% (based on shaved weight) at intervals of 10 minutes. After 70 minutes, the liquor was discharged. The strips were then distributed over separate drums 1 to 15 for drumming.

In each case 4% of copolymer D.1 to D.3 according to the invention or comparative copolymer V-CP.4 or V-CP.5 according to table 1 were added together with 100% of water to the drums 1 to 15 for drumming at from 25 to 35° C. After a drumming time of 20 minutes, in each case 4% of sulfone tanning agent from EP-B 0 459 168, Example K1, and 0.7% of formic acid were subsequently metered. After 60 minutes, in each case 2% by weight of a 50% by weight (solids content) aqueous solution of dyes, whose dyes have the following composition, were metered:

70 parts by weight of dye from EP-B 0 970 148, Example 2.18,

30 parts by weight of Acid Brown 75 (iron complex), Color Index 1.7.16

Drumming was then effected for a further 30 minutes in the drum.

Thereafter, acidification was effected in a plurality of steps of from 0.3 to 0.5% with formic acid to a pH of from 3.6 to 3.8. After 20 minutes, the liquor was assessed with regard to the exhaustion and was discharged. The leathers were washed with 200% of water.

4% of a fat liquor according to WO 03/023069, Example A, were then metered in 100% of water (50° C.). After 20 minutes, acidification was effected with 1% formic acid to the pH of 3.8.

The leathers thus obtainable were washed, dried, staked, treated in a vacuum dryer at 60° C. for 30 sec and rated according to the test criteria set out in Table 1. The leathers LA to L.9 according to the invention and the comparative leathers V-L.10 to V-L.15 were obtained. The rating was effected according to a rating system from 1 (very good) to 5 (poor).

Comparative copolymer V-CP.4 was a random acrylic acid/acrylamide copolymer having a K value according to Fikentscher of 70 (1% by weight solution in water), comonomer ratio in mol %: (acrylic acid:acrylamide) 90:10. V-CP.5 was a random terpolymer prepared from acrylic acid, acrylamide and DMAPMAM (N,N-dimethylaminopropylmethacrylamide), K value according to Fikentscher of 60 (1% by weight solution in water).

The experiments show that the copolymers according to the invention have in particular advantages with regard to the process stability and range of applicabilities. Thus, the leathers according to the invention have excellent process stability without color shifts over a wide pH window and have a constant intensity of the dyeing. The balance of fullness and softness in combination with excellent grain tightness is also remarkable. Altogether, the copolymers according to the invention permit very efficient use of a dye.

TABLE 1
Performance characteristics of leathers according to the invention and comparative leathers

| | | pH | | | Grain | | | Completeness of | |
|---|---|---|---|---|---|---|---|---|---|
| Leather | Copolymer | neutralization | Fullness | Softness | tightness | Levelness | Color intensity | dyeing (section) | Color shift |
| L.1 | (D.1) | 4.5 | 1 | 2 | 1.5 | 1 | 1.5 | 1.5 | None |
| L.2 | (D.1) | 5.3 | 1.5 | 2.5 | 2 | 1.5 | 1 | 1.5 | None |
| L.3 | (D.1) | 6.2 | 2 | 2 | 2 | 1.5 | 1 | 2 | None |
| L.4 | (D.2) | 4.5 | 1.5 | 1.5 | 2 | 1 | 1.5 | 1 | None |
| L.5 | (D.2) | 5.3 | 1 | 2 | 2 | 1 | 2 | 1 | None |
| L.6 | (D.2) | 6.2 | 2.5 | 1.5 | 2.5 | 1 | 2 | 1.5 | None |
| L.7 | (D.3) | 4.5 | 1 | 1.5 | 2 | 1.5 | 2 | 1.5 | None |
| L.8 | (D.3) | 5.3 | 2 | 2 | 1.5 | 2 | 2 | 1.5 | None |
| L.9 | (D.3) | 6.2 | 1.5 | 1 | 2 | 1.5 | 1.5 | 2 | None |
| V-L.10 | V-CP.4 | 4.5 | 2.5 | 3.5 | 2.5 | 3 | 3 | 3 | Red shift |
| V-L.11 | V-CP.4 | 5.3 | 2.5 | 3 | 2 | 2.5 | 2.5 | 2.5 | Red shift |
| V-L.12 | V-CP.4 | 6.2 | 3 | 3 | 2.5 | 3 | 1.5 | 2.5 | Red shift |
| V-L.13 | V-CP.5 | 4.5 | 2.5 | 2.5 | 3 | 2.5 | 3.5 | 2.5 | Red shift |
| V-L.14 | V-CP.5 | 5.3 | 3.5 | 2 | 3 | 2.5 | 2.5 | 3 | Red shift |
| V-L.15 | V-CP.5 | 6.2 | 3.5 | 2.5 | 3 | 2.5 | 1.5 | 2.5 | Red shift |

1.-13. (canceled)

14. A process for the preparation of aqueous formulations which comprises subjecting
(A) at least one ethylenically unsaturated mono- or dicarboxylic acid or the anhydride thereof,
(B) at least one comonomer having at least one permanent cationic charge per molecule and
(C) (meth)acrylamide
to free radical copolymerization with one another in an aqueous medium.

15. The process according to claim 14, wherein the comonomer having at least one permanent cationic charge per molecule (B) is a heterocyclic or acyclic comonomer having at least one permanent cationic charge per molecule.

16. The process according to claim 14, wherein copolymerization is effected at a temperature in the range from 65 to 120° C.

17. The process according to claim 15, wherein copolymerization is effected at a temperature in the range from 65 to 120° C.

18. The process according to claim 14, wherein the comonomers are used in the following weight ratios:
in the range of from 1 to 30% by weight of ethylenically unsaturated mono- or dicarboxylic acid or the anhydride thereof (A),
in the range of from 5 to 60% by weight of comonomer having at least one permanent cationic charge per molecule (B), and
in the range of from 30 to 80% by weight of (meth)acrylamide (C).

19. The process according to claim 17, wherein the comonomers are used in the following weight ratios:
in the range of from 1 to 30% by weight of ethylenically unsaturated mono- or dicarboxylic acid or the anhydride thereof (A),
in the range of from 5 to 60% by weight of comonomer having at least one permanent cationic charge per molecule (B), and
in the range of from 30 to 80% by weight of (meth)acrylamide (C).

20. The process according to claim 14, wherein the ethylenically unsaturated mono- or dicarboxylic acid (A) is acrylic acid or methacrylic acid.

21. The process according to claim 19, wherein the ethylenically unsaturated mono- or dicarboxylic acid (A) is acrylic acid or methacrylic acid.

22. The process according to claim 14, wherein the comonomer having at least one permanent cationic charge per molecule (B) is salts of dimethyldiallylammonium or N-vinyl-3-methylimidazolium.

23. The process according to claim 21, wherein the comonomer having at least one permanent cationic charge per molecule (B) is salts of dimethyldiallylammonium or N-vinyl-3 -methylimidazolium.

24. An aqueous formulation comprising at least one copolymer (D) obtainable by copolymerization of
(A) at least one ethylenically unsaturated mono- or dicarboxylic acid or the anhydride thereof,
(B) at least one comonomer having at least one permanent cationic charge per molecule and
(C) (meth)acrylamide, and
(E) optionally at least one polymeric tanning or retanning agent.

25. The aqueous formulation according to claim 24, wherein polymeric tanning or retanning agent (E) is present and is selected from homo- and copolymers of ethylenically unsaturated carboxylic acids (A).

26. A process for the production of leather which comprises utilizing the aqueous formulations according to claim 24.

27. A leather produced by the process according to claim 26.

28. A copolymer which comprises incorporated in the form of polymerized units:
(A) at least one ethylenically unsaturated mono- or dicarboxylic acid or the anhydride thereof,
(B) at least one comonomer having at least one permanent cationic charge per molecule and
(C) (meth)acrylamide.

29. A mixture of at least one copolymer according to claim 28 with at least one polymeric tanning or retanning agent (E).
